(19) United States
(12) Patent Application Publication
(10) Pub. No.: US 2015/0231654 A1
(43) Pub. Date: Aug. 20, 2015

(54) MATERIAL SPRAYING MACHINE

(71) Applicants: Pursell Manufacturing Corp., Poncha Springs, CO (US); Insulation Technology Corporation, Frederick, CO (US)

(72) Inventors: Paul Pursell, Salida, CO (US); Alan Pursell, Salida, CO (US); Richard Pursell, Salida, CO (US); Raymond W. Lavallee, II, Erie, CO (US); Ryan Dwyer, Thornton, CO (US); Shawn Hurla, Platteville, CO (US)

(73) Assignees: Pursell Manufacturing Corp.; Insulation Technology Corporation

(21) Appl. No.: 14/625,511

(22) Filed: Feb. 18, 2015

Related U.S. Application Data
(60) Provisional application No. 61/941,823, filed on Feb. 19, 2014.

(51) Int. Cl. B05B 7/14

(52) U.S. Cl. CPC B05B 7/1463

(57) ABSTRACT

A material spraying machine is disclosed herein, for example, as the machine may be used to spray flock material. In an example, the material spraying machine includes a hopper configured to hold a material to be sprayed. An agitator in the hopper moves the material from the hopper into an airlock. Vanes in the airlock move the material into an airstream generated by the blower, wherein the material is discharged through an outlet without coming into contact with a blower. The machine is described herein for purposes of illustration as it may be used to spray flock material. However, the machine may have other applications and be used in other industries, including but not limited to, blow-in insulation, confetti, mulch, glitter, etc.

### CROSS REFERENCE TO RELATED APPLICATIONS

This application claims the priority benefit of U.S. Provisional Patent Application No. 61/941,823 filed Feb. 19, 2014 for “Material Spraying Machine” of Lavallee, et al., hereby incorporated by reference in its entirety as though fully set forth herein.

### BACKGROUND

Spraying machines are used to apply a variety of materials to different objects. For example, flocking machines may be used to spray flock material, such as onto Christmas trees.

FIG. 1 illustrates the flow path of flock material through such a conventional, prior art flocking machine 10 having a hopper 12 into which powdered flock material 14 is poured. The arrow ‘A’ represents the combined flow path of the air and material 14. An agitator at the bottom of the hopper 12 forces the material 14 from the bottom of the hopper 12 into a blower 16. The material 14 is then blown through an outlet 18 into a hose and flock gun (not shown). The material 14 is mixed by the flock gun with water, such as from a hose connected to the flock gun, and sprayed out of a nozzle onto an object, such as the Christmas tree. When the water evaporates, the flock material remains on the object.

A typical flocking machine such as that shown in FIG. 1, has a limited maximum material flow rate, e.g., up to about 1.6 pounds of material per minute, thus requiring about 16 minutes to blow about 25 pounds of flock. Further, a typical flocking machine such as that shown in FIG. 1, has a blower that provides a combination of pressure and volume displacement (cubic feet per time displacement) that can propel the flock through only approximately 10-12 feet of hose, limiting the distance between user's application surface and typical machine. Further, flock material 14 flowing through the blower 16 can stick to blower parts, causing clogging, reducing the effectiveness of the blower 16, and requiring frequent cleaning. Additionally, a typical flocking machine draws many airborne particles—including the tacky flock and water vapor—into the agitator and blower motors due to the suction created by their cooling fans. This may cause, over time, further loss of power for the motors, overheating, jamming, and generally reduced life spans for these key components. Finally, a typical flocking machine is made out of metal, which corrodes due to the chemical nature of the flock when combined with water.

### BRIEF DESCRIPTION OF THE DRAWINGS

FIG. 1 is a schematic diagram illustrating a flow path of flock material through a prior art flocking machine.

FIG. 2 is a schematic diagram illustrating a flow path of flock material through an example flock material spray machine disclosed herein.

FIGS. 3-7 show an example of the flock material spray machine disclosed herein.

FIG. 8 is a view inside the example flock material spray machine shown in FIGS. 3-7.

FIG. 9 is a view of interior components of the example flock material spray machine of FIGS. 3-7.

FIG. 10 is a view of the interior of the hopper of the example flock material spray machine of FIGS. 3-7.

FIG. 11 is a close-up view of an airlock as seen in FIG. 10.

FIG. 12 is another view of interior components secured to the bottom of the hopper of the example flock material spray machine of FIGS. 3-7.

FIGS. 13A-B is a view of an example blower control assembly of the example flock material spray machine of FIGS. 3-7.

FIG. 14 is a top view of an airlock rotor assembly of the example flock material spray machine of FIGS. 3-7.

FIG. 15 is an electrical schematic diagram of the example flock material spray machine of FIGS. 3-7.

FIG. 16 is a perspective view of an example nozzle for the example flock material spray machine of FIGS. 3-7

### DETAILED DESCRIPTION

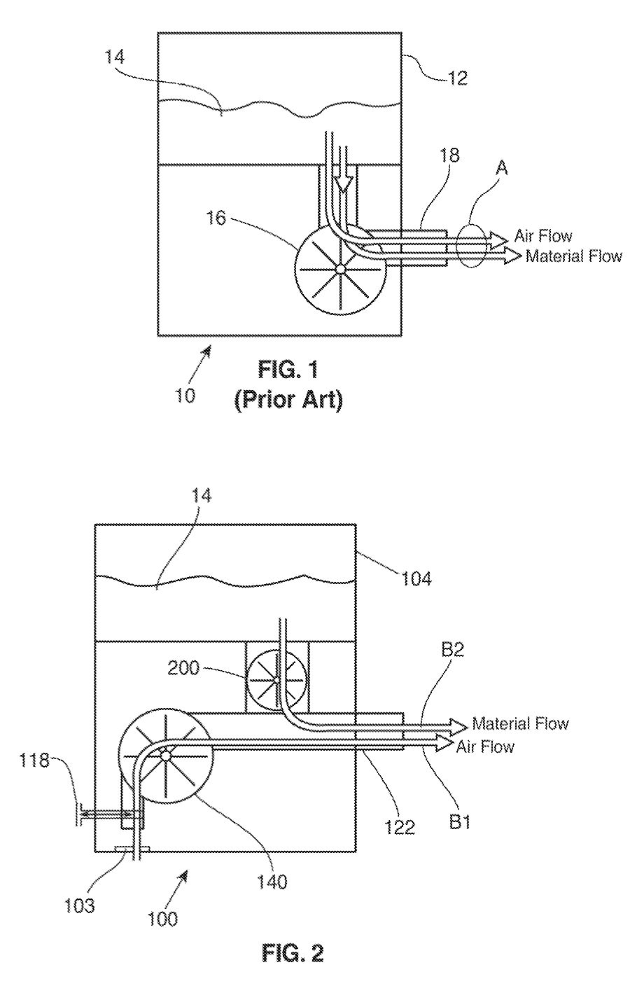

The prior art flocking machine described above with reference to FIG. 1 suffers from the need to continually replace parts and other expensive repairs (e.g., blown motors), in large part because the spray material is carried through the motor itself. As such, the motor is exposed to the spray material and perhaps other airborne debris. In addition, the motor may be underpowered for this purpose, requiring the use of shorter hoses and thus the need to use the prior art flocking machine in close proximity to the application site. The motor is typically housed in an expensive, heavy, corrosive framework, thus making it difficult to move the prior art flocking machine around the application site. The prior art flocking machine has other issues as well, such as a fixed airflow volume that is not adjustable and must be drawn through the material in the hopper. a non-ergonomic applicator, and valves that can easily clog, to name only a few issues experienced when using the prior art flocking machine.

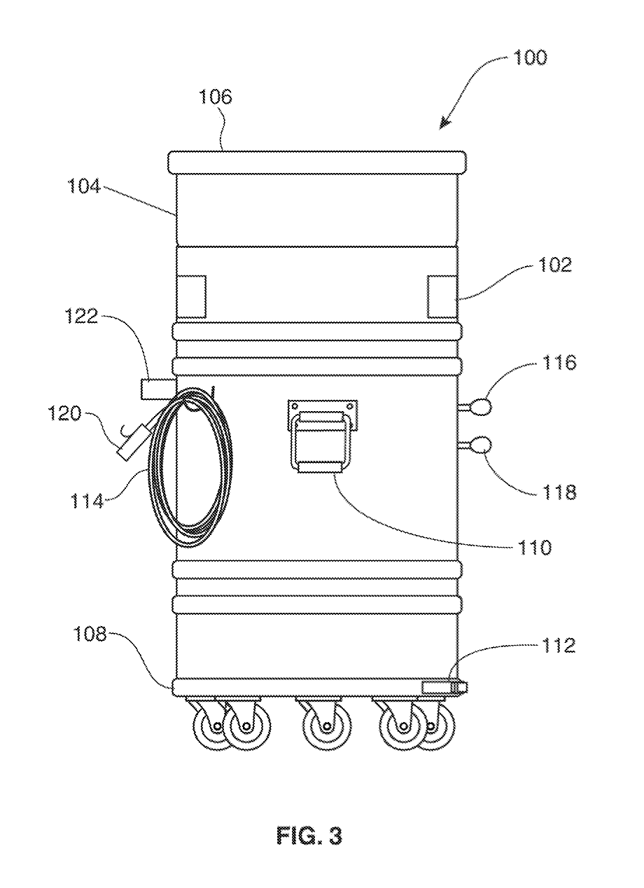

The flock material spray machine disclosed herein addresses these and other issues, and may be implemented to spray flock material on Christmas trees, wreaths, greenery, movie and stage sets, and landscapes, Other spray material may include, but is not limited to, blow-in insulation, mulch, or confetti. FIG. 2 is a schematic diagram illustrating a flow path of flock material 14 through an example flock material spray machine 100. In an example, the flock material spray machine 100 includes a hopper 104 to hold the flock material 14. Arrows ‘B1’ and ‘B2’ represent separate flow paths of air and flock material 14, respectively.

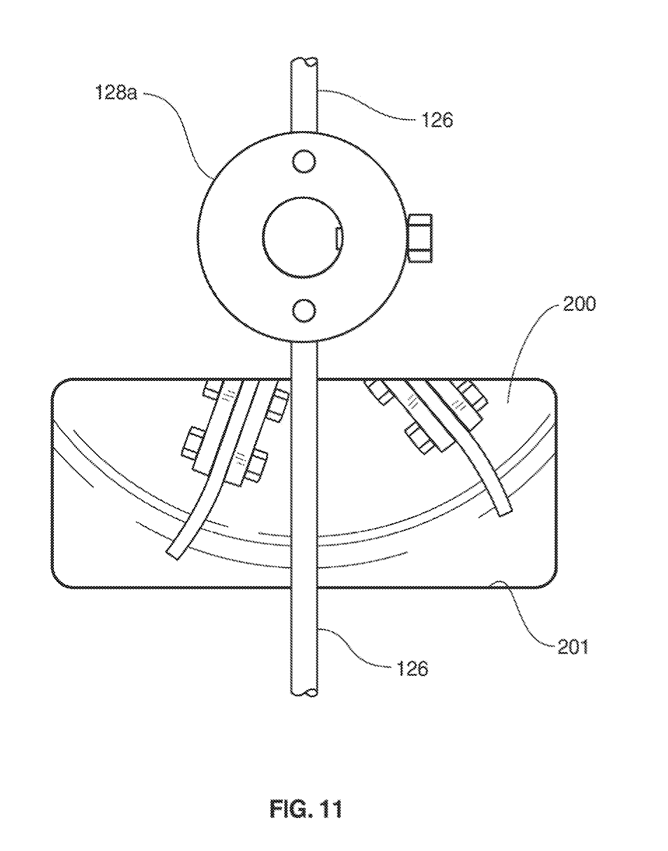

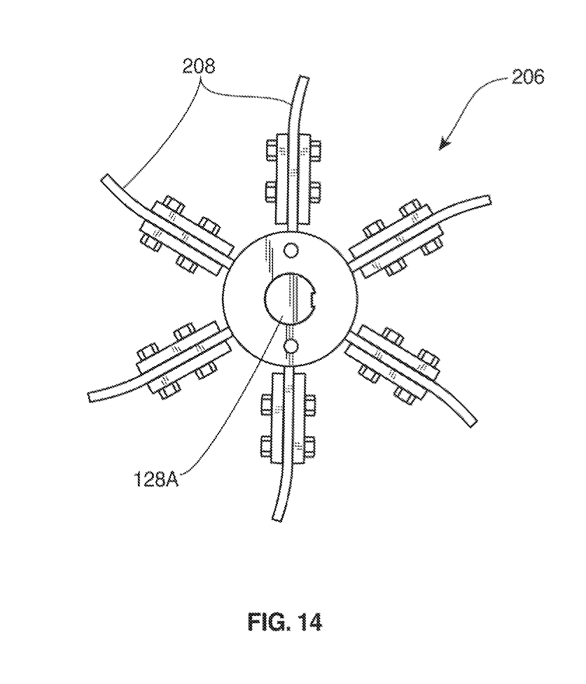

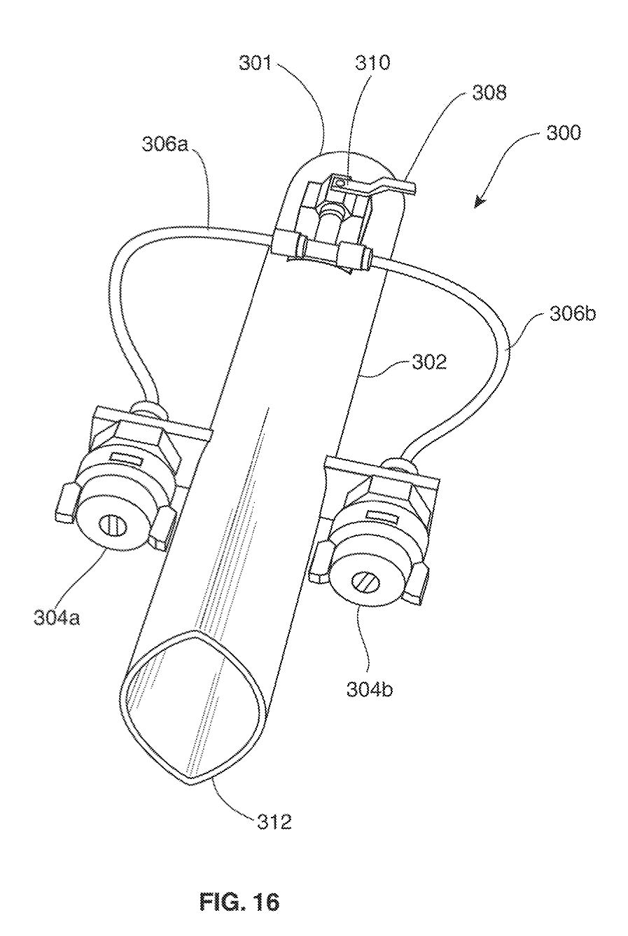

The example flock material spray machine 100 also includes an agitator (see, e.g., 126 in FIG. 10) in the hopper 104. The agitator moves the flock material 14 (e.g., from the bottom of the hopper 104) through an opening in the hopper 104 and into an airlock 200. Rotating vanes (see, e.g., FIG. 14) in the airlock 200 then move the flock material 14 into an airstream generated by a blower 140 such that the flock material 14 is discharged through an outlet 122 (e.g., into a hose and flock gun 300 shown FIG. 16). As such, the flock material 14 does not enter the blower 140 and cannot, therefore, stick to the fan blades, axle assembly, and/or other components of the blower 140. In addition, the airlock 200 feeds the flock material 14 into the airstream at a regulated rate, thus reducing or altogether eliminating “pulsing.”

Before continuing, it is noted that as used herein, the terms “includes” and “including” mean, but are not limited to, “includes” or “including” and “includes at least” or “including at least.” The term “based on” means “based on” and “based at least in part on.” The terms “flock” and “flock material” refer to a dry material which may include a self-adhesive that is water activated such that it sticks to a surface on contact (or shortly thereafter, e.g., upon drying).

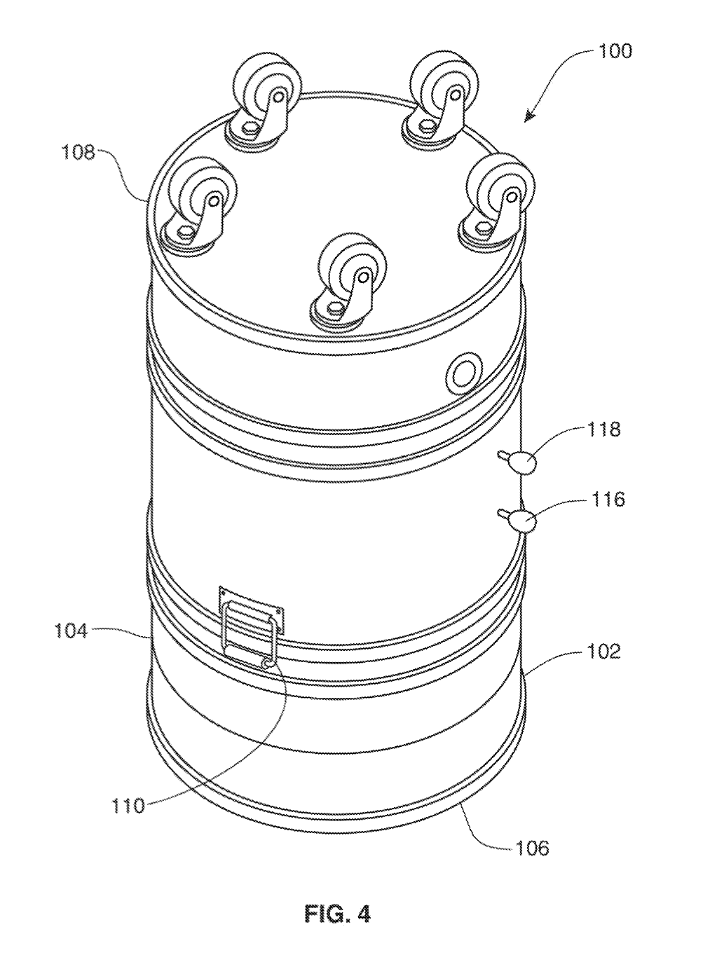

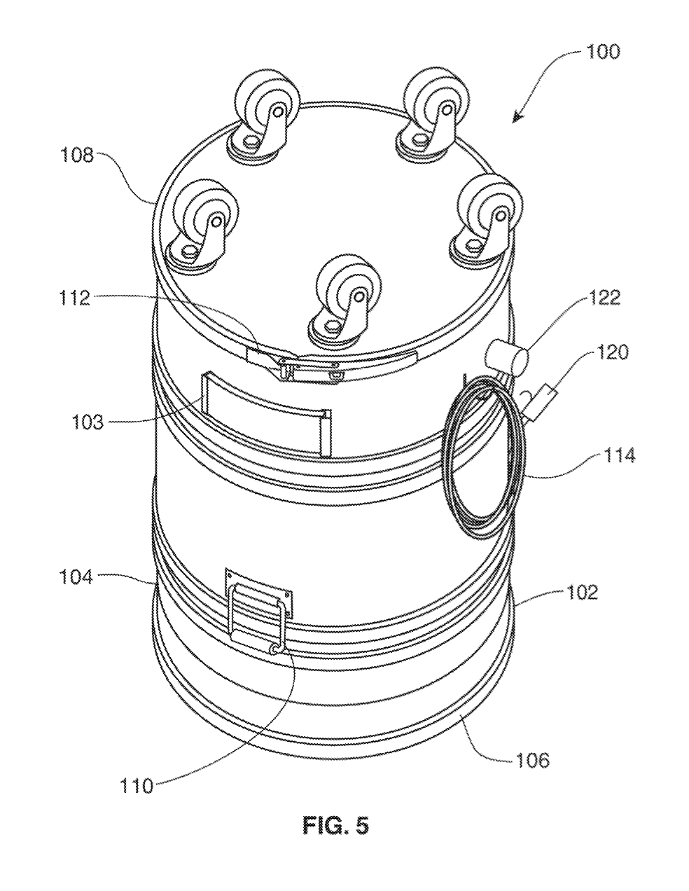

FIGS. 3-7 show an example flock material spray machine 100. The machine 100 includes a housing 102 and a material hopper 104 that fits within the housing 102. Only the top portion of the hopper 104 is visible in FIG. 3 as the remainder is within the housing 102. A removable lid 106 on top of the hopper 104 may cover the opening of the hopper 104 to contain flock material 14 and prevent contamination. In an example, the removable lid 106 may include handle(s) (not shown).

The housing 102 and hopper 104 of the flock material spray machine 100 may be made from such materials as plastic, aluminum, or stainless steel, to avoid the corrosion issues that are common in conventional flocking machines. In an example, the housing 102 provides a two-part, non-corrosive, tool-free access, sealed motor cavity. The example housing for the motor(s) (e.g., agitator/airlock, and blower) is sealed, and incoming air is filtered. The two-piece design uses inexpensive, lightweight, non-corrosive materials.

In an example, the flock material spray machine 100 is sealed to allow internal airflow to be accomplished through a desired inlet. Clean air is provided to the blower 140 by a filter 103 on the outside of the housing for air intake. The filter 103 filters out airborne particles, including but not limited to the tacky flock and water vapor being sprayed nearby. Only filtered air is allowed to enter the agitator and blower motors, prolonging their life and reducing maintenance. This configuration also seals in and protects the motorized parts, but permits easy access to those parts with a simple clamp access system that requires no tools. In addition, the use of a direct outside air source improves the volume of air available, because the air is not drawn through the material in the hopper.

The flock material spray machine 100 is designed to deliver (spray) dry material using a forced air system. Flock material 14 is contained in the hopper 104, and is drawn into a motorized airlock 200 by the use of a powered agitation system. The flock material 14 is then drawn from the airlock 200 into a blower system having hoses through which air is forced by motorized fans to propel the dry material for the desired application.

The air lock device is a unique configuration that allows dry material to be propelled using forced air without going through the blower motor/fan. An example configuration employs a unique 90 degree mounting system. However, the flock material spray machine 100 is not limited to a 90 degree mounting system. In another non-limiting example, the airlock may be provided in-line with the airflow. In any configuration, the flock material 14 does not enter the blower motor, instead feeding the flock material 14 into the airstream created by the blower 140.

A power cord may be provided to plug into an electrical outlet to provide power to the flock material spray machine 100. Material flow and air flow adjustment handles 116, 118 on the side of the housing 102 and a low-voltage (e.g., 24 v) remote control 120 on the end of a cable 114 enable an operator to control various aspects of the operation of the flock material spray machine 100. A hose (not shown) with a flock gun (see, e.g., FIG. 16) on the end may be connected to a material outlet 122 on the side of the housing 102.

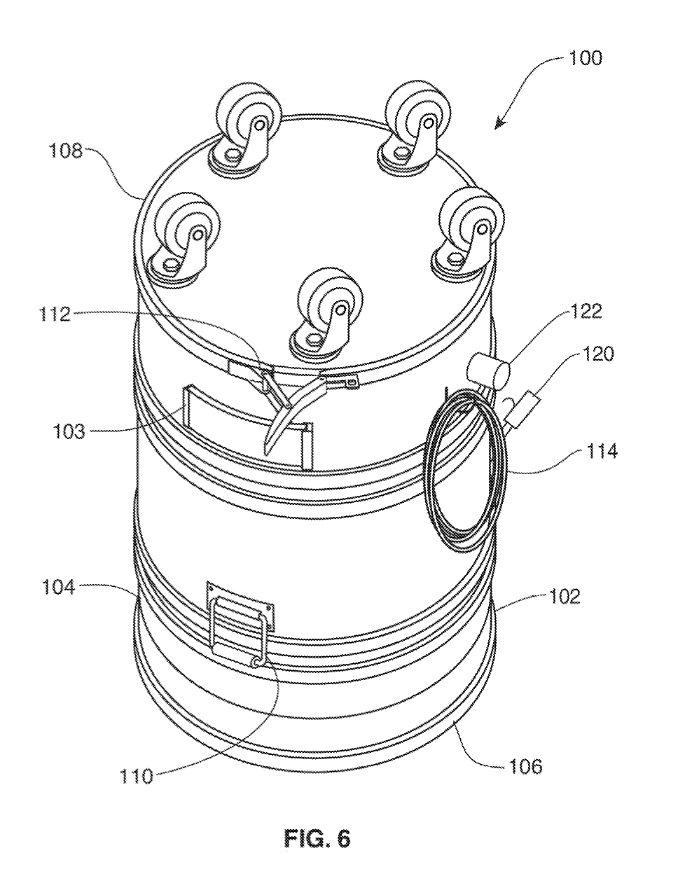

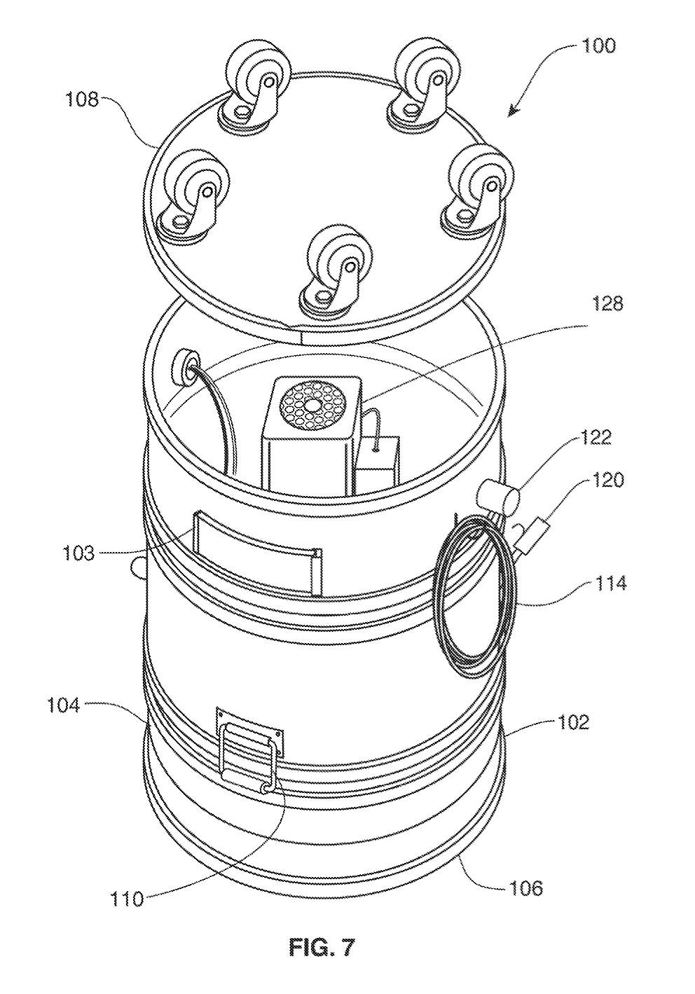

In an example, the housing 102 may be mounted on a wheeled base 108 and have handles 110 for transporting, The wheeled base 108 may be removably secured to the housing 102 with a lever 112 or other fastener(s). See, e.g., the illustration of FIGS. 5-6.

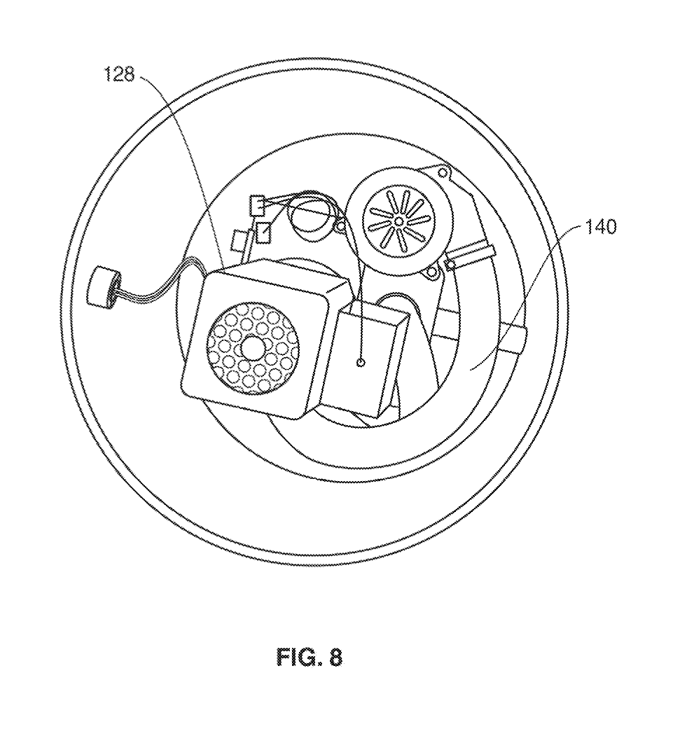

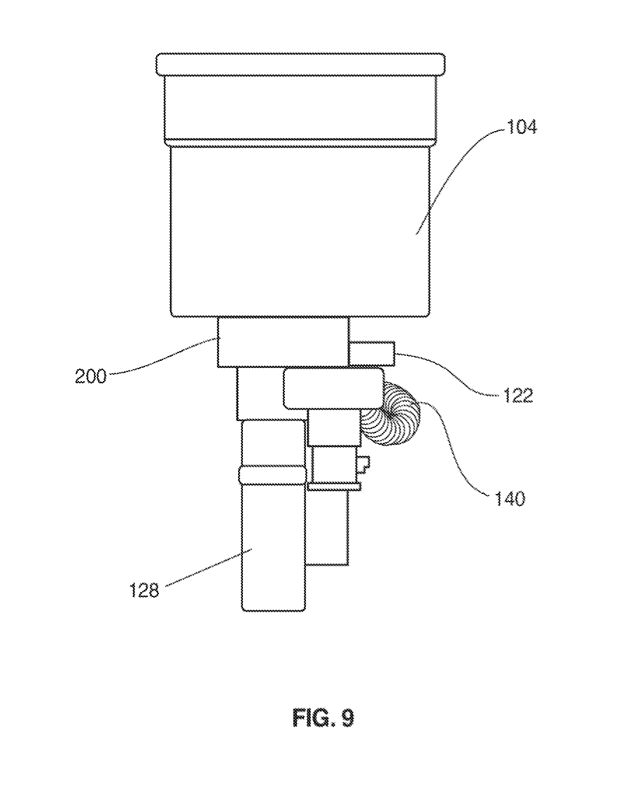

When the housing 102 is turned upside down, the base 108 may be removed to allow access to components internal to the housing 102, as illustrated by FIGS. 7-8 and discussed in more detail below. To remove the housing 102, the entire machine 100 may be turned upside down. Then the lever 112 or other fastener may be unlatched and various connectors unfastened, and the housing may be removed from the hopper 104 to access the motors, ducting, and other components. Thus, the flocking machine 100 disclosed herein does not require tools to access the internal components. In an example, the base 108 may be removed from the housing 102, and the housing 102 may be separated from the hopper 104 (e.g., by further removing the adjuster levers 116 and 118).

Before continuing, it should be noted that the examples described above are provided for purposes of illustration, and are not intended to be limiting. Other devices and/or device configurations may be utilized to carry out the operations described herein.

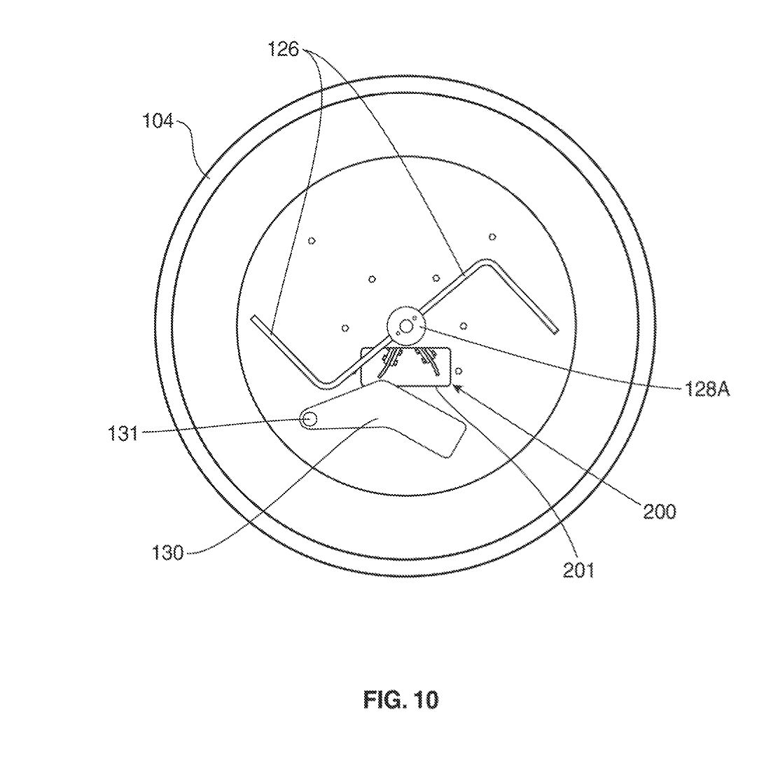

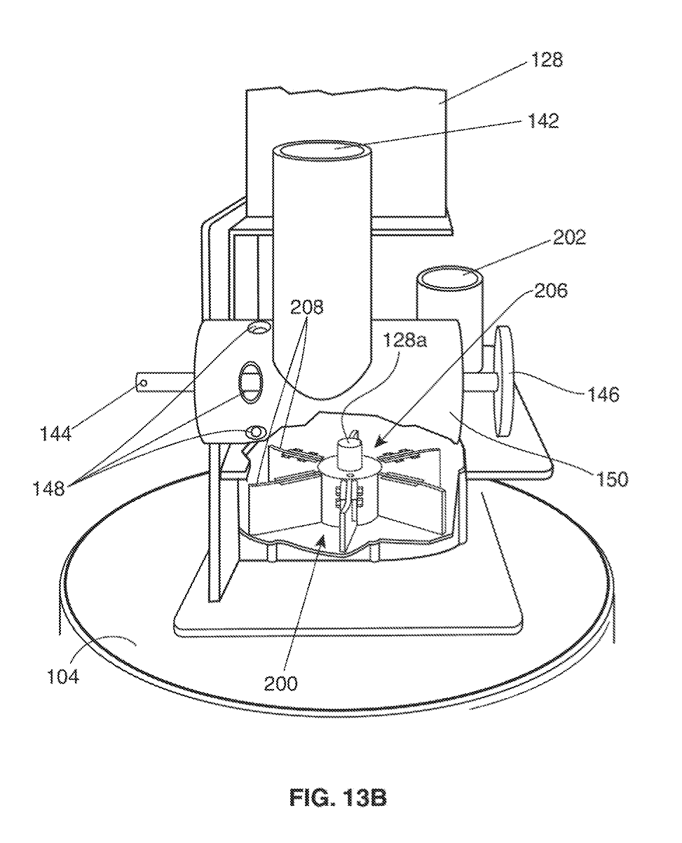

FIG. 8 is a view inside the example flock material spray machine 100. FIG. 9 illustrates components within the flock material spray machine 100 after the housing 102 has been removed. The internal components may include blower 140, airlock 200, and motor 128. A motor shaft 128A (see, e.g., FIG. 10) extends from the motor 128 through the airlock 200, where it is connected to the airlock vanes (see, e.g., FIGS. 13B and 14), and through the bottom of the hopper 104 to connect with an agitator 128A in the hopper (see, e.g., FIG. 10).

FIG. 10 is a view looking down into the interior of the hopper of the example flock material spray machine 100. As shown in FIG. 10, the agitator 126 may be secured to the end of the motor shaft 128A inside the hopper 104. Thus, a single motor 128 can be provided to drive both the agitator 126 in the hopper 104, and the vanes 208 within the airlock 200.

As further illustrated in FIG. 10, an opening 201 through the hopper 104 provides a passageway for material 14 to move into the airlock 200 in response to the rotating action of the agitator 126.

Also shown in FIG. 10 is a material slide gate 130, which is at the entrance to the airlock 200 and is controlled through a linkage arm by the material flow adjustment handle 116 on the outside of the housing 102 (FIG. 3). By pushing or pulling the material flow adjustment handle 116, the operator may close and open the slide gate 130 (e.g., rotating about pivot 131), thereby adjusting the rate at which flock material enters the airlock 200.

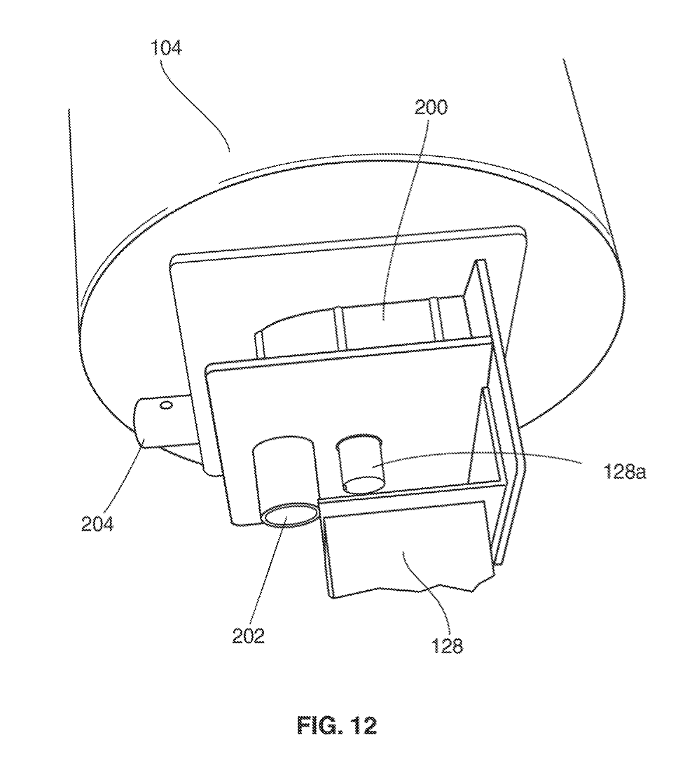

FIG. 11 is a close-up view of an airlock seen in FIG. 10. As previously explained above with reference to FIG. 1B, the airlock 200 enables the flock material 14 to enter an airstream generated by the blower 140 without coming into contact with the blower 140 itself.

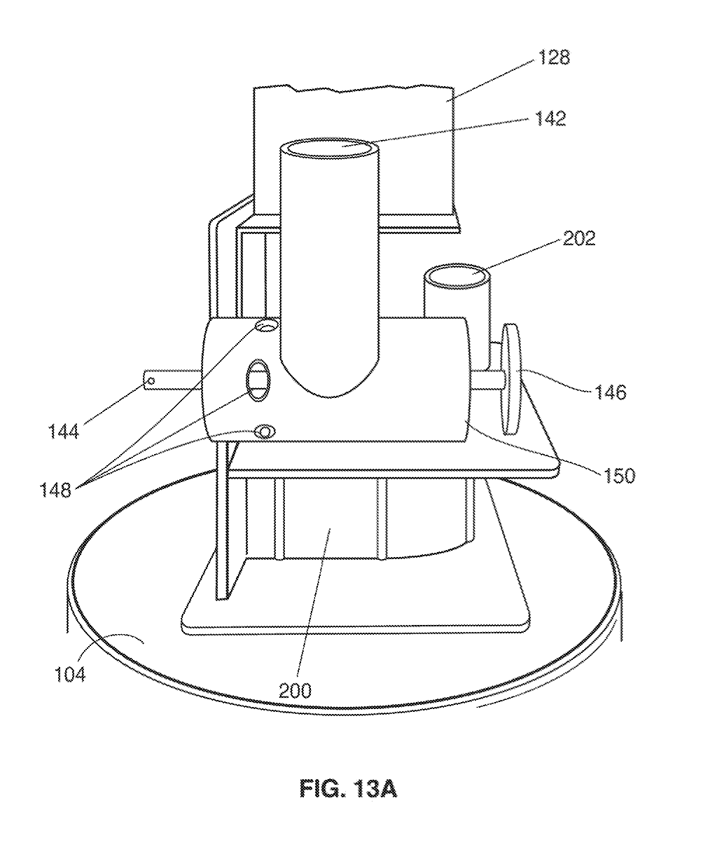

FIG. 12 is another view of interior components secured to the bottom of the hopper of the example flock material spray machine 100. FIGS. 13A-B show a view of an example blower control assembly of the example flocking machine 100. FIG. 13A is a view (upside down) of an embodiment of a blower control assembly of the flocking machine 100. The assembly includes an air inlet 142 connected to the blower 140 (not visible in FIG. 13A). A blower flow control rod 144 is substantially perpendicular to the air inlet pipe 142 and is operated by pulling and pushing the airflow adjustment handle 118 on the outside of the housing 102. A diverter disk 146 (e.g., made of rubber or other like material) is secured to one end of the control rod 144, and operated to control airflow through one or more air release holes 148 in the sides of the assembly. An air outlet 150 is connected to the airlock inlet 202.

The flock material spray machine 100 also offers the unique feature of bleeding of the air pressure in the application system via an adjustable force of air/bleed system. In an example, the air flow of the flock material spray machine 100 may have a mechanical adjustment, allowing the blower 140 to operate at a constant full speed. In operation, full air flow is achieved by operating the control rod 144 (e.g., moving the control rod 144 in a direction that is towards the left in FIG. 13A) until the disk 146 is in front of the air inlet pipe 142 (e.g., to the left of the air inlet pipe in FIG. 13A and to the right of the air release holes 148). As such, all of the air flows from the inlet pipe 142 through the assembly and out the outlet 150.

To reduce air flow to the airlock 200, the control rod may be operated (e.g., moved in a direction that is towards the right in the FIG. 13A) so that the disk 146 intersects the air inlet pipe 142. As it does so, some of the air is diverted out the air release holes 148, reducing the amount of air flowing out the outlet 150 into the airlock 200, and slowing the flow of flock material 14 from the flock material spray machine 100.

For illustrative purposes, the control rod 144 and diverter disk 146 are shown FIG. 13A as being pushed in until the disk 146 is visible past the opening of the outlet 150 on the right side of the assembly. In an example, the blower assembly outlet pipe 150 is connected by tubing to the airlock inlet 202. The flocking machine 100 enables the user to adjust both the air flow and the material flow.

FIG. 13B is more detailed view of interior components secured to the bottom of the hopper 104 of the flock material spray machine 100. In an example, one end of an airlock inlet 202 is connected to the blower 140 to provide an airflow into the bottom of the airlock 200. Flock material 14 enters the top of the airlock 200 from the hopper 104, is transported through the airlock 200 by an airlock rotor assembly 206 (see detail shown in FIG. 14), and is forced by the airflow out of an airlock outlet/material outlet 122 in the side of the housing 102. As previously noted, both the agitator 126 in the bottom of the hopper 104 and the airlock rotator assembly 206 in the airlock 200 may be driven by the shaft 128A of the single motor 128.

The configuration of the airlock 200 is unique in that it is mounted at about 90 degrees relative to the airflow generated by the blower 140. As such, flock material 14 enters through a sidewall of the airlock 200 (see, e.g., FIG. 13B), where it is entering perpendicular to the sides of the airlock seals 208. The flock material 14 is discharged through what is conventionally the entrance direction, such that the flock material 14 is flowing perpendicular to the tips of the airlock seals 208 of the airlock 200. Rotating the airlock 200 in this manner further reduces the amount of space required within the flocking machine 100 and also allows a single motor 128 to drive both the agitator 126 and the vanes in the airlock 200.

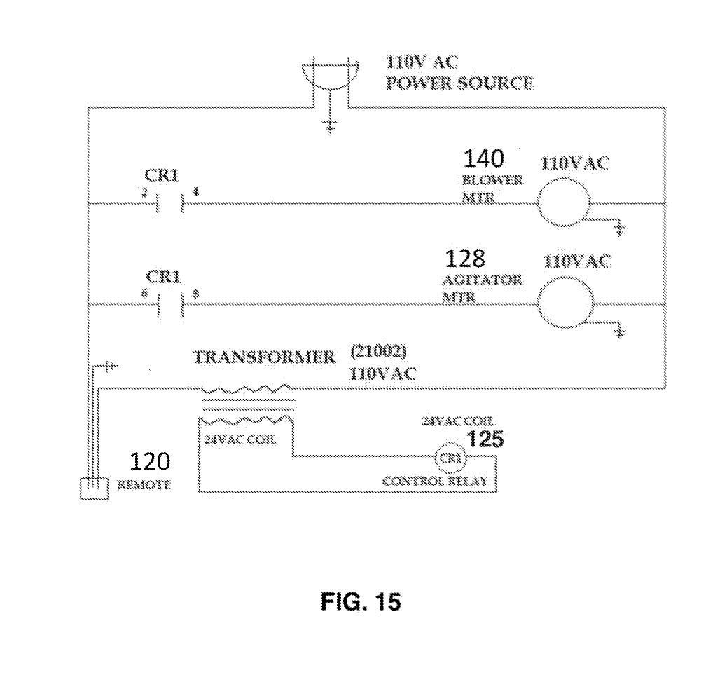

FIG. 15 is an electrical schematic diagram of the example flock material spray machine 100. The circuit illustrates a power source, a motor for the blower 140, and a motor for an agitator 128. It is noted, however, that the same motor may be used to operate both the blower 140 and the agitator 128. The circuit also includes a low-voltage remote control 120 that may be used to turn the blower motor 140 and agitator/airlock motor 128 on and off. A control relay may be provided. Other control circuitry may also be provided.

It should be noted that the examples described above are provided for purposes of illustration, and are not intended to be limiting. Other devices and/or device configurations may be utilized to carry out the operations described herein. By way of further illustration, another example of the flock material spray machine may include any size, shape, position or other configuration of the components. For example, more than one agitator and the agitator(s) may be provided at any position within the hopper. The motor may include one or more chain drive (e.g., instead of direct drive). The motor may be variable speed. Multiple filters may be provided. Other components may be provided (mechanical, electrical and/or a combination thereof) for controlling air flow and/or material flow. Safety mechanisms may be provided. The airlock may be provided directly in-line with the airflow generated by the blower (while still preventing flock material from becoming entrained in the blower.

FIG. 16 is a perspective view of an example nozzle or “flock gun” for the example flock material spray machine 100. Applicators are typically clumsy and difficult to operate for extended periods, causing fatigue and clogging. Some applicators require the operator to squeeze a handle or hold a button to power the water or machine. The nozzle 300 eliminates these problems and offers a flexible ergonomic design. The example nozzle 300 has a tube portion 302 which may be connected at end 301 to a hose (not shown) for connection at the outlet 122 to deliver the flock material 14 through outlet end 312. It is noted that although shown to be generally cylindrical in shape with an oval shaped discharge opening 312, the nozzle 300 may have any desired size, shape, and configuration.

For application of the flock material 14, the flock material spray machine 100 may also include a liquid application system. In an example, the liquid application includes liquid sprayer (not shown) and a nozzle 300. The example liquid sprayer may include a reservoir and a pump. In another example, the liquid sprayer may include a reservoir for the liquid, and be configured to discharge liquid from the reservoir through operation of the motor and/or airflow generated by the flock material spray machine 100.

The liquid sprayer may be attached to the nozzle 300 (e.g., at connection port 310). Liquid discharge can be controlled by valve 308 (e.g., turned on/off and the flow volume adjusted). Tubing 306a and 306b connect the connection port 310 to output ports 304a and 304b, respectively, In an example, the output ports 304a and 304b are dual fan-shaped liquid sprayers. However, any number and/or configuration of output ports 304a and 304b may be provided. The dual fan shaped liquid sprayers 304a and 304b are adjacent the airflow through which the dry material is forced as it is applied. These sprayers 304a and 304b may be recessed behind the fan shaped dry material outlet to prevent clogging due to the proximity of the material coming from the main hose outlet.

In addition, the angle of the two liquid fan sprayers may be configured so that spray intersects at a center point about 3 feet from the gun and directly in the path of the flock material 14 being discharged from the gun. Such a configuration helps ensure saturation of the dry flock material 14 in the matrix formed by the sprayers. Of course, other configurations are also contemplated. By way of illustration, additional water sprayers may be provided.

The liquid spray enables the dry flock material 14 to be infused with a liquid (e.g., water) or adhesive as it is being applied, so that the flock material 14 sticks on contact.

The nozzle 300, in conjunction with the configurations and controls described above (e.g., adjustment handles 116 and 118), enable the user to adjust both material flow and liquid volume, and the distance the flock material 14 is thrown from end of a hose, thereby providing flocking control and precision for the operator. Having a gate to prevent the amount of product from flowing into the air path and the ability to fine-tune the amount of flock coming out of the nozzle by being able to adjust both the volume (i.e., quantity—controlled by gate) of material being sprayed, and pressure (i.e., distance thrown—controlled by blower control) of material is unique and a benefit to the user.

In an example, the flocking machine 100 disclosed herein may produce a variable material flow rate of between about 0 and 5.5 pounds per minute, enabling an operator to blow about 25 pounds of flock in about 4.5 minutes, substantially faster than with conventional machines. Further, because of the increased air pressure, a longer hose (e.g., about 15-30 feet in length) may be readily used, allowing the operator more mobility as he or she flocks Christmas trees, wreaths, greenery, movie and stage sets, and landscapes in different application areas.

It is noted that the examples shown and described are provided for purposes of illustration and are not intended to be limiting, it is further noted that the machine 100 has been described and illustrated for use as a flocking machine for illustrative purposes. However, the machine 100 may find applications in other industries and/or for other purposes, such as but not limited to, blow-in insulation. Still other examples are also contemplated.

1. A method of spraying material, comprising:
providing a blower configured to draw outside air;
configuring an airlock with a material flow path substantially perpendicular to an airstream generated by the blower;
providing an agitator to move the material into the airlock without coming into contact with the blower; and
moving the material out of the airlock and into he airstream generated by the blower for discharge through an outlet.

2. A. material spraying system, comprising:
a blower configured to draw outside air;
an airlock configured with a material flow path substantially perpendicular to an airstream generated by the blower;
a hopper configured to hold material;
an agitator in the hopper to move the material from the hopper into the airlock without coming into contact with the blower; and
vanes in the airlock to move the material into the airstream generated by the blower to discharge the material through an outlet.

3. A flock material spraying machine, comprising:
a hopper configured to hold flock material;
an agitator in the hopper to move the flock material from the hopper into an airlock; and
vanes in the airlock to move the flock material into an airstream generated by the blower, wherein the flock material is discharged through an outlet without coming into contact with a blower.

4. The flock material spraying machine of claim 3, further comprising adjustments to fine-tune an amount and a force with which the flock material is discharged through the outlet, the adjustments including both volume adjustment and pressure adjustment.

5. The flock material spraying machine of claim 3, further comprising a removable base of a housing, the removable base providing access to operational components within the housing.

6. The flock material spraying machine of claim 3, further comprising a housing having a motor cavity sealed from the hopper and agitator.

7. The flock material spraying machine of claim 3, further comprising a housing having a filtered inlet

8. The flock material spraying machine of claim 3, wherein only filtered outside air enters the agitator and the blower.

9. The flock material spraying machine of claim 3, further comprising a single motor to drive both the vanes and the agitator.

10. The flock material spraying machine of claim 9, further comprising a motor shaft of the single motor connected to the vanes and the agitator.

11. The flock material spraying machine of claim 3, further comprising a material slide gate at an entrance of the airlock, the material slide gate adjustable to control a flow rate of the flock material.

12. The flock material spraying machine of claim 3, wherein the flock material enters through a sidewall of the airlock and flows perpendicular to tips of airlock seals of the airlock.

13. The flock material spraying machine of claim 3, further comprising a blower flow control rod and a diverter disk configured to mechanically adjust airflow of the blower even when the blower is operating at a constant speed.

14. The flock material spraying machine of claim 13, wherein the blower flow control rod mechanically adjusts flow of the flock material between about 0 and 5.5 pounds, to deliver about 25 pounds of the flock material in about 4.5 minutes using a delivery hose of up to about 30 feet in length.

15. The flock material spraying machine of claim wherein the airlock delivers the flock material into the outlet at about 90 degrees relative to airflow through the outlet.

16. The flock material spraying machine of claim 3, further comprising a hose and flock gun attached to the outlet.

17. The flock material spraying machine of claim 16, wherein the flock gun is configured to adjust water application to the flock material exiting the flock gun.

18. The flock material spraying machine of claim 16, wherein the flock gun has dual fan-shaped liquid sprayers adjacent an outlet through which the dry material is forced during application.

19. The flock material spraying machine of claim 18, wherein the sprayers are recessed behind a fan-shaped dry material outlet to reduce or prevent clogging.

20. The flock material spraying machine of claim 18, wherein the sprayers are configured at an angle on the flock gun to discharge a liquid intersecting at a center point directly in the path of the flock material being discharged from the gun.
